(19) United States
(12) Patent Application Publication
(10) Pub. No.: US 2002/0005346 A1
(43) Pub. Date: Jan. 17, 2002

(54) Method and apparatus for extracting hydrocarbons from tar sands using electro plasma

(76) Inventor: Peter D. Babington, Ontario (CA)

Correspondence Address: Clark & Brody, Suite 600, 1750 K Street, NW, Washington, DC, 20006, US

(21) Appl. No.: 09/897,026

(22) Filed: Jul. 3, 2001

Related U.S. Application Data
(63) Continuation-in-part of application No. 09/227,337, filed on Jan. 8, 1999.

(51) Int. Cl. B01J 19/08

(52) U.S. Cl. 204/168; 422/186

(57) ABSTRACT

An in-situ method and apparatus for recovering hydrocarbons from hydrocarbon-bearing material by dissociation includes sinking a well casing into a deposit of the hydrocarbon-bearing material. A probe is inserted into the well casing until the probe end is adjacent the deposit of material. An electrical charge is released into the deposit via the probe end to dissociate the hydrocarbon-bearing material and produce a hydrocarbon rich product which can be recovered for fuel value.

This application is a continuation-in-part of application no. 09,227,337 filed on Jan. 8, 1999, which is a divisional of application no. 08,743,806 filed on Nov. 5, 1996, and now U.S. Pat. No. 5,868,919.

### FIELD Of THE INVENTION

The present invention is directed to an improved in-situ method of recovering of hydrocarbon-rich material from hydrocarbon-bearing deposits such as tar sands, and in particular to the use of an electro-plasma process and apparatus for in-situ recovery.

### BACKGROUND ART

Various techniques have been proposed to recover the hydrocarbons contained in tar sand deposits. Some techniques require the tar sands to be mined first and then processed in various reactors to recover the inherent fuel values in the sands. For example, U.S. Pat. No. 4,344,839 to Pachkowski teaches a process where the tar sands are mined and injected into a plasma stream in a reactor. The hydrocarbons are vaporized and then recovered. U.S. Pat. No. 5,356,524 to Sackinger discloses another method using a reactor.

Other techniques use in-situ methods wherein the hydrocarbons are recovered from the actual tar sand deposits. U.S. Pat. No. 4,067,390 to Camacho uses a plasma arc torch to strip off the volatiles and recover product gases. U.S. Pat. No. 5,336,524 to Circeo et al. also uses a plasma torch, but for vitrification of the land fill material as a contaminant rather than for recovery of energy values.

The fusing of tar sands in-situ and other industrial uses is not well known in the field of oil drilling. Each year millions of tons of tar sands are surface mined in solid form, later to be steam heated down into a sandy crude. This method has inherent problems. The main problem being labor intensive and the exclusive use of high maintenance equipment as well as expensive remediation.

Both above ground and in-situ techniques suffer from a number of other drawbacks. Techniques requiring mining and processing equipment above ground involve massive amounts of capital costs. When mining the tar sand, the muskeg and overburden (as much as 75 m thereof) must be removed prior to accessing the tar sands. Prior art in-situ techniques while considerably less expensive then mining methods still do not provide an efficient mode of recovery.

Thus, a need exists to provide improved methods and apparatus to recover the fuel values in deposits such as tar sands. The present invention accomplishes this aim by the use a dissociation process heretofore applied in reactor settings, in an in-situ application, whereby significant recovery of the hydrocarbons found in tar sands is possible.

The dissociation process and apparatus are disclosed in U.S. Pat. No. 5,868,919 to Babington et al., which is hereby incorporated in its entirety by reference. In this patent, a dissociation process and apparatus employs a probe and trigger to release vast quantities of energy at the probe tip without harming the material being treated. However, the Babington patent does not recognize that the dissociation process can be applied in-situ for recovering hydrocarbons in tar sands, oil shale and the like.

### SUMMARY OF THE INVENTION

One object of the present invention is the use of an electro-plasma method and apparatus to recover hydrocarbon-rich material from a hydrocarbon-bearing deposit in situ.

Another object of the invention is a method and apparatus that employs a mobile unit that can be easily sited for the in-situ recovery.

A further object of the invention is a method of recovering hydrocarbons from hydrocarbon-bearing deposits in an efficient and productive manner.

Other objects and advantages will become apparent as a description of the invention proceeds.

In satisfaction of the foregoing objects and advantages, the invention is an improvement in a method of dissociating materials by first providing a material to be dissociated, subjecting said material to at least one cycle of a release of an electrical charge in a time span on an order of a nanosecond to impact a cycle shock front to the material for dissociation; and recovering at least one of said medium/media and at least one dissociated product from said subjecting step, wherein the dissociation is performed in a reactor. According to the invention, the dissociation is performed in-situ and by subjecting a deposit of hydrocarbon-bearing material to the at least one cycle and recovering a dissociated hydrocarbon-rich product from the subjecting step. Preferably, the hydrocarbon-bearing material is a tar sand deposit.

In a preferred embodiment, the method uses a well casing inserted into the hydrocarbon-bearing material and a probe for electrical discharge, an end of a probe being inserted into the well casing until the probe end is in proximity to the deposit. The electrical charge is then released through the probe and into the deposit to create a fusion layer of hydrocarbon-rich product for recovery. The subjecting step can be repeated for continued recovery of the hydrocarbon-rich product, the probe being lowered further into the deposit with each cycle repetition.

The method also includes the use of a grounding rod tip disposed adjacent the probe end, the grounding rod trip connected to either a grounding rod extending back through the well casing and to ground or a ground rod extending into ground below the probe end. The grounding tip can be adjustably spaced from the probe end to vary the spacing for control of the electrical discharge.

The invention is also an improvement in apparatus for dissociating materials that comprise a power supply; a capacitor for storing an electrical charge supplied by the power supply; a trigger switch for discharging the electrical charge stored in the capacitor in a time span on an order of a nanosecond; at least one probe, one end connected to the trigger switch for receiving the electrical charge discharged by the trigger switch, the other end of the probe immersed in the media; and a ground circuit including a ground tip disposed opposite an end of said probe, and a ground connector providing connection between ground and said ground tip, wherein the apparatus employ a reactor. According to the invention, no reactor is needed, the dissociation can be done in-situ by extending a well casing or other boring-type article into a deposit of hydrocarbon-bearing material. The well casing provides a channel for positioning the probe within the well casing, and the probe end adjacent a portion of the deposit. The deposit of hydrocarbon-bearing material can then be subjected to the electrical charge to form a dissociated hydrocarbon-rich product for subsequent recovery.

The apparatus can be either mounted on a mobile unit or fixedly supported at a particular site. The ground tip can be adjustable with respect to the end of the probe to vary the spacing therebetween for more control of the process. The ground connector can connect to ground below the probe end that extends through the well casing or to ground outside of the casing by extending up through the well casing.

Other features of the apparatus and method include the trigger switch being configured to release the stored energy in as short a time as about a nanosecond or greater. The capacitor should be designed to release up to 100 kilovolts in the nearly instantaneous discharge time.

More than one probe can be used and the electrical discharge can be repeated on the material depending on the desired treatment.

According to the dissociation method, the hydrocarbon-bearing material is disassociated by subjecting it to a cycle shock front. The dissociation caused by the energy of the electrical discharge can break up the material treated into simpler constituents or modify its make up depending on the material treated. It is believed that subjecting the hydrocarbon-bearing material to the cycle shock front will produce a hydrocarbon-rich product devoid of the byproduct sands, which is then much higher in fuel value, and can then be removed conventionally so as to recover the fuel values in a cost effective manner.

### BRIEF DESCRIPTION OF THE DRAWINGS

Reference is now made to the drawings of the invention wherein:

FIG. 1 is a dissociation apparatus employing a reactor;

FIGS. 2 and 3 show a circuit diagram for the apparatus of FIG. 1;

FIG. 4 shows an apparatus for an in-situ use of the dissociation method;

FIG. 5 shows one probe assembly as part of the apparatus of FIG. 4;

FIG. 6 shows an alternative probe assembly; and

FIG. 7 is a schematic of an exemplary use of the inventive apparatus for recovering hydrocarbons from tar sands.

### DECRIPTION OF THE PREFERRED EMBODIMENT

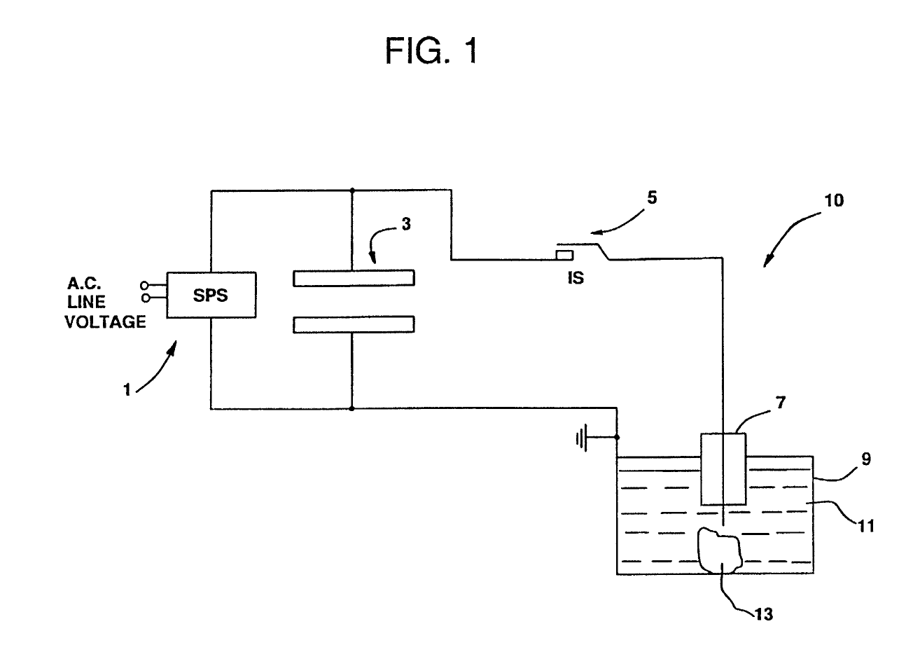

With reference now to FIG. 1, an apparatus employing a reactor is generally designated by the reference numeral 10 and is seen to include a switching power supply (SPS 1) which provides an electrical charge cumulatively to a capacitor 3. When sufficient voltage is created across the capacitor (voltage =charge/capacitance), an instantaneous high voltage switch 5 allows transfer of the charge held by the capacitor to a probe 7 which is disposed within an electrically grounded treatment reactor 9 filled with a medium 11 and a material 13 to be treated. As will be discussed below, the material to be treated could be a component part of the medium in the reactor 9. The medium/media can also be a liquid, solid or gas in conjunction with the material to be treated.

Voltage approaching 100 kilovolts can be developed across the capacitor 3, preferably sized between 0.05 and 2 microfarads, before it is operated to allow the charge to find its way to electrical ground via the interior of the treatment vessel 9 through the medium/media 11. Since the capacitor and the switching power supply is sized to provide up to 100 kilovolts to the capacitor in approximately one to eight seconds, the discharge of the capacitor could be as rapid as every two to three seconds to repeatedly treat the material 13 in the reactor 9.

Exemplary of a trigger device for the inventive apparatus is a high voltage spark gap switch Model No. 40-264 which is manufactured by Maxwell Technologies, Inc. of San Diego, Calif. This switch has a voltage rating of 25 to 100 kilovolts with a maximum peak current of 100 kiloamps. Of course, other high energy trigger switches as are known in the art or equivalent to the Maxwell Corporation type described above can be used in the inventive apparatus. Similarly, high energy capacitors which are known can be utilized to release the voltage necessary to generate the cycle front as described above.

It is believed that during the near instantaneous dumping or release of the charge from the capacitor 3 via the switch 5 to the probe 7 and ground, several different phenomena occur in the reactor. For description purposes, the passage of the charge from the probe 7 to ground via the material to be treated is termed “a cycle” and the phenomena created by the charge release is termed “cycle front”.

While not being bound by any exact theory for the phenomena which occurred during the cycle, it is believed that the cycle front technology can best be described as follows:

When electrical energy is suddenly released into a medium/media, intense mechanical-like shock waves are created. The wave is characterized by a steep leading edge and a minor bubble pulse trailing at its end. The cycle front or “electro-hydraulic effect” is an easy way to convert electrical energy into direct work. The duration of the discharge is in the range of one to hundreds of nanoseconds. Electrical cycle-front power, released by the discharge, reaches 10³-10⁵ KW while the energy density into the discharge channel reaches 10⁸-10⁹ J/m³.

Complex physio-chemical phenomena are believed to occur in medium/media in the following steps:

a) formation of a conductivity channel,

b) widening of this channel,

c) post-discharge processes.

The breakdown starts by creating a few leaders, consisting of electrons and ions, leaders that are emitted mainly from a positive probe. The probe and/or the deflector insert can be machined to any configuration to suit the material which is to be treated. The leader stage ends when the gap bridging occurs, or when one of the leaders reaches the negative probe or ground, or when the two leaders meet. The breakdown time depends on voltage level, probe shape, and conductivity of the medium/media. Variations in the range of a few to hundreds of nanoseconds (10⁻⁹ seconds) is typical.

After the medium/media gap has been bridged, the second stage of the electrical discharge starts. The larger part of stored energy is released here. When a substantial amount of energy is released in the cycle-front channel, a complicated gaseous system (discharge plasma) is created which, as a result of its parameters, is a dense low temperature plasma [temperature about (1.5-4.0)×10⁴ ° K. pressure (10-30)×10 ³ atmospheres]. The discharge plasma within the medium/media converts circuit electrical energy into internal energy through a channel (heat movement, ionization, dissociation and excitation of particles), mechanical energy from shock waves (compression and motion of media elements) and electromagnetic radiation.

Dumping a large amount of energy instantaneously into the small space of a cycle-front channel will raise its temperature and enlarge the channel. The surrounding media resists this intrusion. Therefore, discharging large amounts of energy into a medium/media momentarily causes high pressures which create standing shock waves. The shock waves act as a main power force of this technology. The instant the shock waves are created, their frontal pressure reaches tens of thousands of atmospheres which consists of neutrons that are responsible for the velocity becoming supersonic. Violent vibrations are caused which helps break up suspended matter.

After the circuit energy input stops, the discharge product expansion undergoes extensive cooling with a chain of internal conversions resulting in the creation of a steamgas cavity within the medium/media. Internal and kinetic energy within the charged medium/media causes radical oscillation within the cavity. During the oscillation process, cavity-type pressure fluctuates considerably (10³-10⁴ times). After the cavity radius reaches its maximum, the pressure drops to a few millimeters of mercury and the cavity starts to collapse. The starting pressure in the cavity is about 40 atmospheres with the expansion speed of its walls around 40 meters per second and cavity lifetime is slightly higher than the discharge time.

Considering the cycle-front shock waves as the primary force and the cavity shock waves as secondary, the duration of the secondary wave is 30 to 45 times longer than the primary waves. The peak pressure and energy are 10 times lower but the pressure's impulse is of the same order.

Cycle-front discharges in medium/medias are accompanied by powerful cavitation processes. Of all the phenomena accompanying the electro-plasma treatment, the passing of intense acoustic waves in medium/media cavitation is the most known and, at the same time, the least studied physical process. Research of changes occurring in the microstructure during the cycle discharge showed that immediately following the discharge there are numerous gas bubbles in the medium/media. These bubbles occupied up to 15-20 percent of all medium/media volume surrounding the breakdown area, although after 1 to 3 minutes only 5 to 7 percent were left.

The cavitation process is accompanied by mechanical (shock waves), thermal (heating of cavity content as a result of a rapid shrinking) and electrochemical effects on the cavitation medium/media and substance therein.

Capacitor operation in a “charge/discharge” mode requires a greater amount of time for energy storage than for energy release time. This makes it possible to obtain a time-based (10⁻⁹ sec) instantaneous discharge power in the megavolt range by using energy sources in the kilowatt range. The amount of energy released in a discharge channel depends on many factors, such as: the length of the working cycle-front; parameters of the discharge circuit (voltage, capacitance, inductance); area and shape of the probes; and properties of medium/media. Electrical efficiency of electro-plasma devices range between 50 to 85 percent and can be adjusted in either direction by controlling discharge conditions within a certain mode. Exemplary parameters believed to occur during the cycle-front include:

Pressure (10-30)×10³ atmosphere

Temperature (1.5-4.0)×10⁴ ° K.

Light Wavelength 500-6,900 Angstroms

Ultrasonics 300-1,500 Khz; 5-15 w/cm²

Discharge Current 10-450 ka

Intensity 10³-10⁹ j/cm²

Duration 10⁻³-10⁻⁹ seconds

Impact Waves Velocity 18,100 m/second.

The physical phenomenon that accompanies the cycle-front treatment of aqueous solutions can create such products as ozone, hydrogen peroxide, hydroxyl ions, which are great oxidants/reductors in many chemical reactions. Generation of hydrogen peroxide is beneficial when whitening materials.

For example, a high energy input will force and ionize an electron from a molecule of water (H₂O-e→H₂O⁺) causing the following reaction to occur:

H₂O→H+OH;

OH+OH⁻→H₂O₂;

H+H⁻→H₂;

20→O₂;

H+O₂→HO₂;

OH+H₂−→H₂O+H;

2H₂O→H₂O₂+H₂;

H₂O₂+OH→H₂O+HO₂;

O₂→O+O;

O+O₂−→O₃;

H₂O₂+HO₂−H₂O+O₂+OH etc.

All the aforementioned cycle-front conditions take place within one to several nanoseconds.

The system can also include a computerized control system which monitors the power to the capacitor and trigger as well as the material delivery and retrieval systems. This control system also has capability for receiving and recording data from all components of the system as well as providing communications either in the form of the electronic data or printed data for record-keeping or the like.

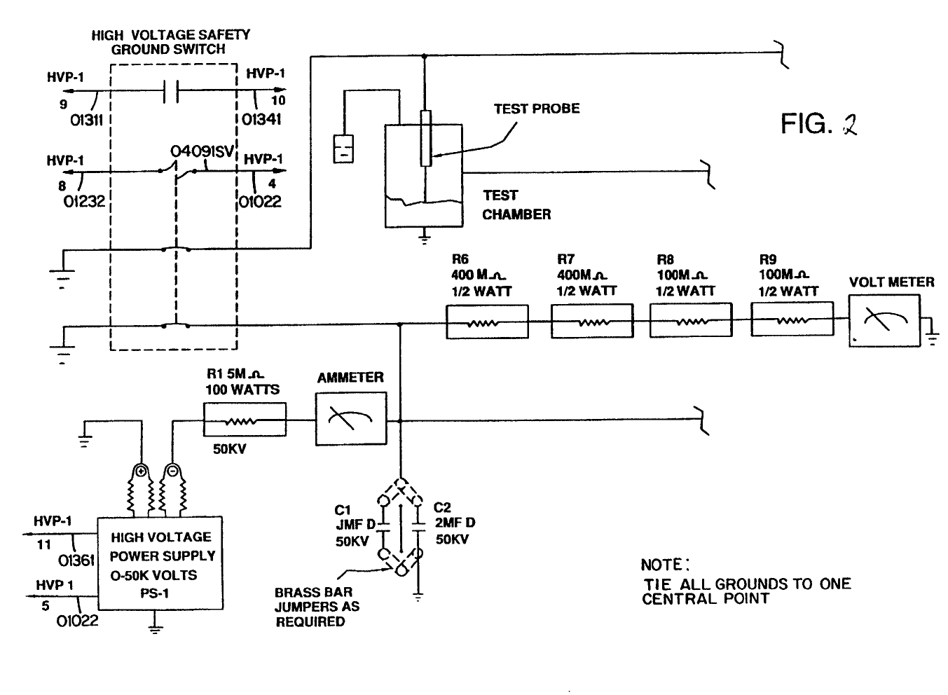

Referring now to FIGS. 2 and 3, an exemplary circuit diagram is depicted. The circuit diagram provides further description concerning the components and circuitry described in FIG. 1 and describes a preferred embodiment of the invention. The circuit, generally designated by the reference numeral 80 begins with a high voltage power supply ranging from 0 to 50 kilovolts, designated as PS-1. This a conventional power supply and can use any of the standard supply voltages typically available, e.g., 110, 240 or 480 volts. Preferably, the primary side of the high voltage power supply receives 110 volts.

On the secondary side of the high voltage power supply is a ground switch designated by the reference numeral 81. The ground switch is designed as safety mechanism to discharge the probe in the test reactor as well as the high power circuitry. The ground switch 81 can be tripped automatically, for example, when the test reactor 9 is positioned in a reactor service area (not shown) and an operator or other worker enters the reactor service area. An auxiliary contact on the ground switch 81 interlocks the high voltage power supply primary source to assure that no recharge is attempted. The automatic tripping, although disclosed when operating personnel enter the reactor service area, can be configured for other safety purposes as will be known in the art.

Downstream of the ground switch is a 5 megaohm 100 watt resistor (R1) which controls the rate that the supply capacitors C1 and C2 are charged. An ammeter is disposed downstream of the resistor R1 to monitor the flow of current to the supply capacitor C1 and C2. The ammeter will show movement when high voltage power supply is supplying the capacitor C1 and C2.

The supply capacitors C1 and C2 are configured to accommodate a number of power requirements. The dotted lines on the top and bottom of the supply capacitors represent a movable bus connection to the ends of the capacitors. This will allow connection to the high voltage circuit and a number of series/parallel configurations which will permit testing different materials under different conditions.

A voltmeter is also supplied which is calibrated to monitor the charge supply of the supply capacitors C1 and C2. The resistors R6, R7, R8 and R9 upstream of the voltmeter are used to drop the current and voltages of the voltmeter. The resistors are only exemplary and other resistors could be used to allow the voltmeter to operate properly.

The high voltage spark gap switch SG is located downstream of the supply capacitors C1 and C2. The spark gap switch SG is a switch that controls the timing of the arc in the test reactor 9. The spark gap switch utilizes two control circuits for operation, i.e. an air control and a trigger circuit.

The air control includes a compressed air source from a compressor which is fed to the ball valve V1, filter F1 and regulator RG1. These components condition the air to be pressurized in the gap switch SG. A purge SV1 evacuates the spark gap switch between each cycle. Speed of the evacuation will be regulated with a flow valve FW1. The safety check is also incorporate in air circuit in the form of a pressure switch PS 1. If the pressure switch is not made, i.e. meaning that the instrument air is not on, the high voltage power supply will not be able to operate.

The spark gap trigger circuit R2, R3, R4, C3, L1, C4 and 0311 CR, initiates the actual discharge of the power circuit. R2 and R3 supplied biasing voltage to the spark gap trigger switch. This voltage in itself is not enough to initiate the switch closure. The pulse transformer L1 converts 12 VDC from the main control cabinet to 30 KV. The pulse transformer output is held low with 0311 CR contacts. When the 0311 contacts are open via a control (not shown), the pulse transformer L1 will fire a 30 KV spike from C4 through C3 and R4 into the spark gap trigger switch. The spike combined with the biasing voltage from the high voltage power supply initiates the power circuit discharge into the test reactor 9.

The present invention is an improvement in the dissociation method and apparatus disclosed in the aforementioned Babington et al. patent in the discovery that this method and apparatus offers improvements when used to recover the hydrocarbons in hydrocarbon-rich deposits such as oil shale and tar sands, particularly tar sands. The invention uses the electro hydraulic effect (which is one aspect of the electro plasma science) in the recovery process to be carried out in situ using leading edge technology, technology designed without moving parts. Using the disclosed method and apparatus, it is anticipated that there will be little or no breakdown time during processing, no expensive tool wear, no need to remove water from muskeg, no removal of the muskeg or overburden to get to the tar sands and no operational hazards; thereby providing a method and apparatus that is safe, reliable, and efficient. There is no need for huge shovels and trucks or lengthy conveyor systems to carry chunks of tar and sand mixture to the refinery or other processing site.

In a preferred embodiment, the inventive method consists of the following steps:

1. The sinking of a regular oil well casing to the depth of the tar sands. This casing to be sunk through the muskeg without first removing the top water from it.

2. Continue to sink the metal casing through the overburden.

3. When the casing is clear and down to the surface of the tar sands, it is ready for the electro hydraulic plasma probe to be lowered into it until it rests on the tar sands.

4. The first release of the plasma will be directed downward, liquefying the tar sands so the probe can be lowered further into the tar sands.

5. The second release of the plasma will travel outward causing a supersonic spreading of the fusing points.

6. The solidified tar sands can be pumped to the surface and into a forcemain that will carry it to the refinery.

This method of tar sands fusion will be beneficial to:

1) The workers because there will be no explosives, no heavy dangerous equipment to cause injury to the operators.

2) The environment because there is no harmful chemicals left behind. There is no need for expensive remedial clean-up.

3) The industry because the equipment does not have expensive moving parts; capital costs and operating costs are extremely low.

Scientific research has revealed that when the electro hydraulic plasma process accomplishes the fusion of the tar sands it:

1) Slurries the solid tar and sand deposits downward and outward for a predetermined number of meters.

2) Then the sand will leach to the bottom leaving the near sand free crude, ready to be pumped to the surface and forcemained to a refinery.

In order to accomplish this, three separate electro plasma processes will be employed to recover the hydrocarbons from the tar sands as is described in the Babington et al. patent when using a reactor. They are electro thermal plasma heating, electro thermo mechanical plasma heating, and electro hydraulic plasma heating. The details of each are described below.

Electro Thermal Plasma Heating

This method requires a continuous duty DC power supply capable of producing very high voltage to a capacitor bank, which stores energy until it is triggered across a spark gap controller to the work fixture.

Required also are specially designed electro plasma probes that will produce extremely high temperatures at the work face where it is anticipated the intense heat will travel at supersonic speed, causing instantaneous expansion from the mechanical shock waves created from the excessive thermal heating of upwards to a million degrees centigrade. This extreme temperature lasts for only one to a few nanoseconds. The surrounding product remains cool to the touch.

Electro Thermo Mechanical Plasma Heating

The stationary plasma method will cause the energy force to act downward. The electro plasma probe will be installed in the well casing to rise up and down automatically causing them to rest against the solid tar sands where it is calculated the direct plasma blast causing it to solidify. The plasma probe will continue down through the liquified tar sands until it rests once again on solid tar sands where this process will be repeated. The electro plasma probes will be sized and constructed to accommodate each in-situ situation, wherein the probe size can be adapted to fuse a certain amount of tar sands per pulse.

Electro Hydraulic Plasma Heating

The electro hydraulic effect (EHE) employs all the conditions used in the previously mentioned plasma heating methods.

The equipment needed for fusion by means of the EHE can be built on mobile units so it can be transported and used on site. Based on studies of the EHE process, I/\it is believed that the EHE plasma technology when completed will liquefy large portions of the solid tar sands. Because of the nature of the EHE plasma heating method, normal activities can be carried on around the work site while it is operations. It is further believed that the EHE effect is more efficient when used underground than in an open environment such as a pit since more energy can be focused on the material being treated. The use of electro-plasma techniques for recovering these types of materials is also more environmentally-friendly.

In a preferred embodiment, the apparatus for tar sand recovery would have a main power supply, banks of high energy capacitors, a high energy spark gap trigger, a high voltage air supply system, a high voltage safety interlock system, capacitor ground to high voltage ground, and a spark gap switch using air for operation. The apparatus would employ safety measures to ensure operator safety as would be within the skill of the art.

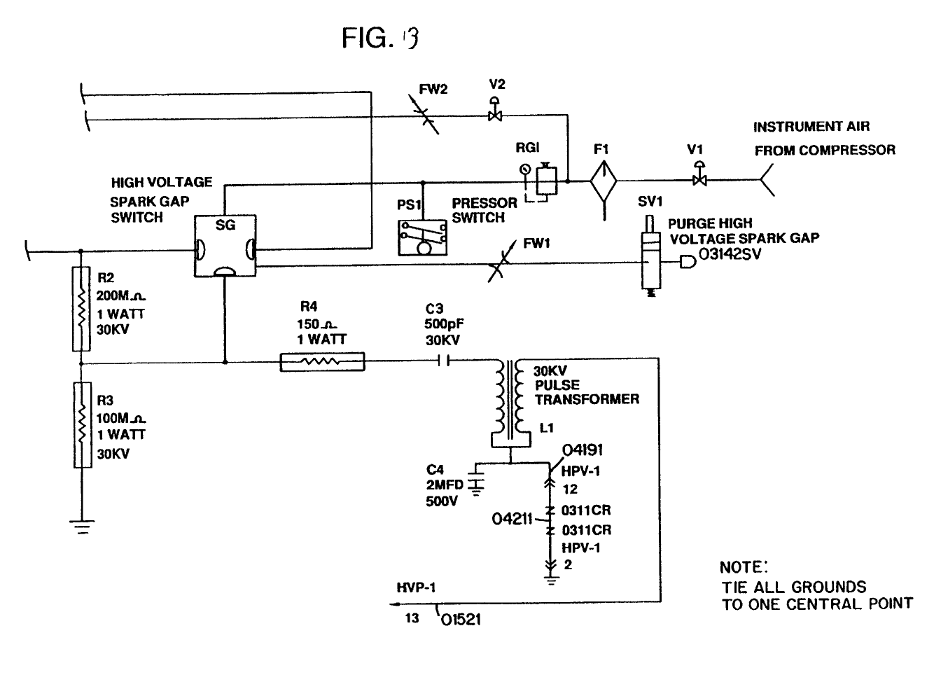

FIG. 4 shows one example of a mobile unit 20 that is adapted for recovering hydrocarbon-rich material from a deposit such as tar sands. The unit 20 has a crane 21 designed to support the probe assembly 23. A hydrocarbon-rich product recovery assembly is designated by the reference numeral 25, the assembly designed to move the fused product into the tanker 27 for further processing.

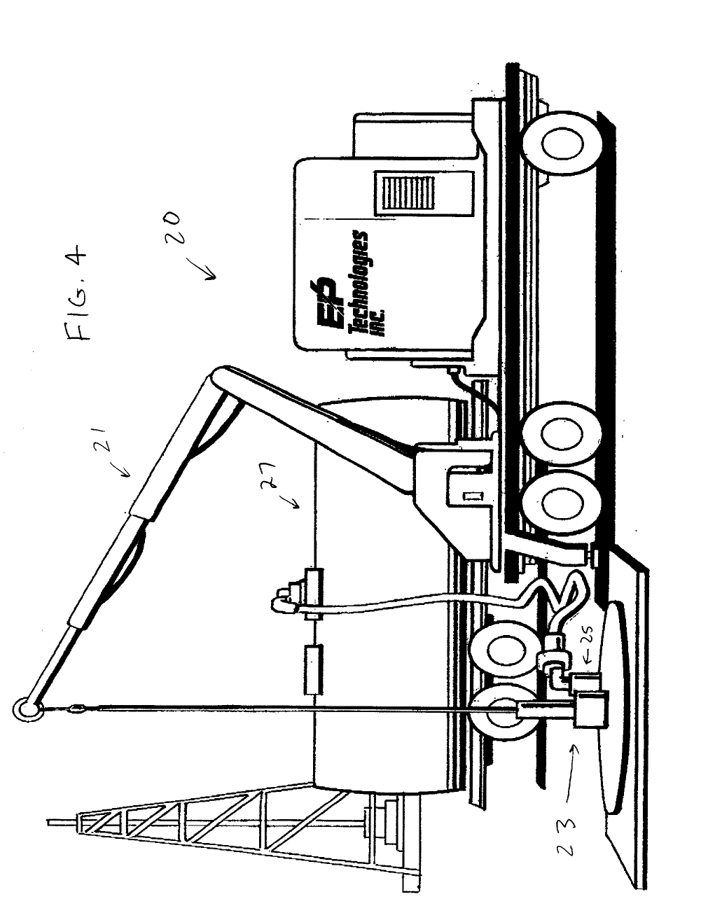

The probe assembly is shown in FIG. 5 wherein the assembly 25 is inserted into a well casing 31. The probe assembly 25 includes an insulator 33 that surrounds a positive electrode 35, the incoming power line designated as 36. This power line corresponds to the same power line shown in FIG. 1 entering probe 7. A ground rod 37 is fastened to the insulator using conventional means and is disposed within the casing 31. The ground rod 37 with outgoing grounding wire 38, terminates in a ground tip 39 that faces the tip 36 of the electrode 35.

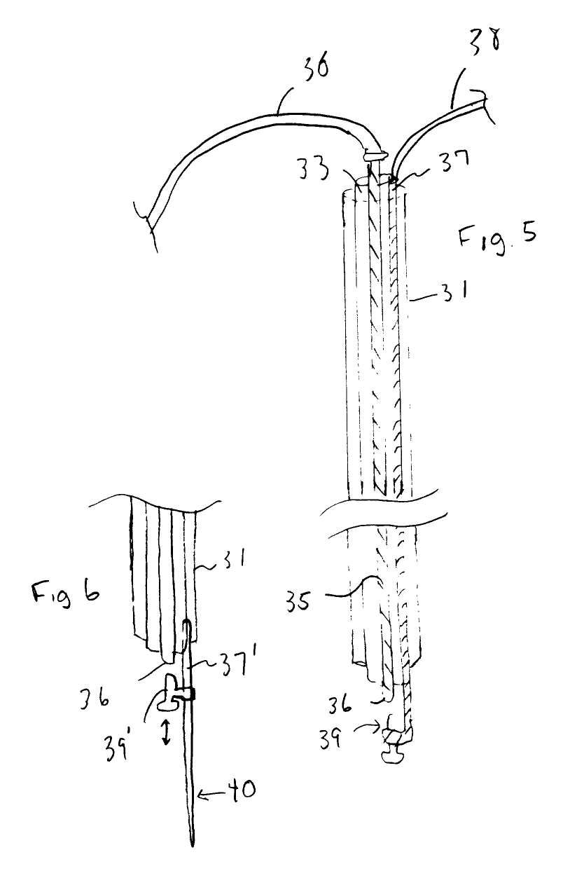

FIG. 6 shows a ground rod 37′ and an adjustable ground tip 39′. In this embodiment, the ground rod 37′ extends beyond the well casing 31 and electrode tip 36. The ground tip 39′ can move along the length of the rod 37′ so that the spacing between the ground tip 39′ and the electrode tip 36 can be varied. In this embodiment, the grounding rod 37′ is inserted directly into the deposit a given length for grounding purposes, much like a grounding rod is inserted into the ground for lightning protection. This contrasts with FIG. 5 wherein the ground is run up the probe and to a grounding source outside of the well casing.

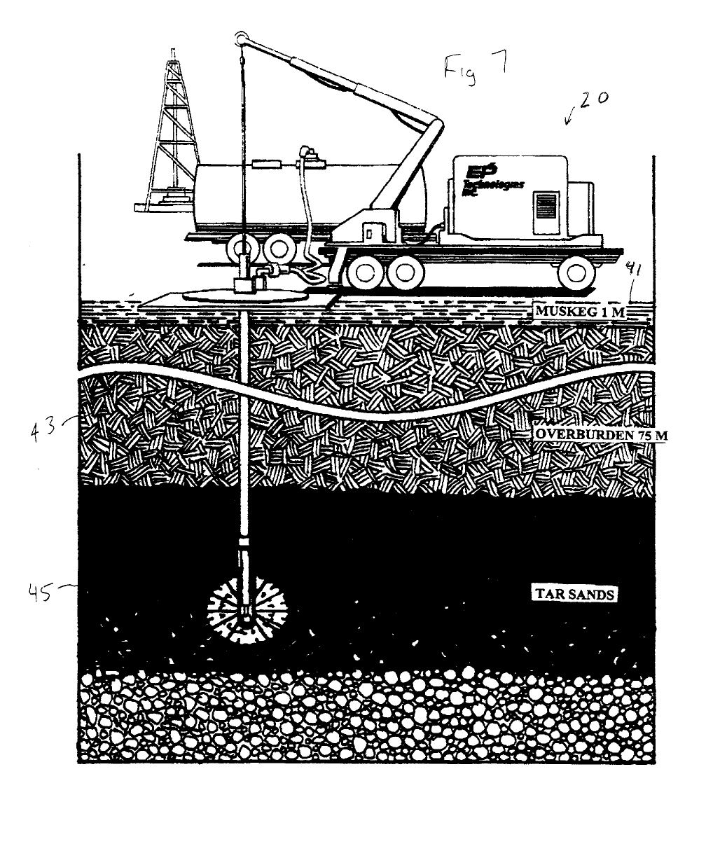

FIG. 7 shows the mobile unit 20 in an exemplary use in a tar sand deposit. The well casing 31 penetrates the muskeg 41, the overburden 43, and is positioned within the tar sand deposit 45. The well casing 31 is driven or drilled into these layers as any well casing would be when attempting to recover oil deposits or the like, and the material displaced by the well casing is removed as done conventionally.

Once the well casing 31 is inserted into the ground, the casing 31 can be raised to create a cavity for the electrode 35 and ground tip 39, or the well casing 31 can be left in place. The probe assembly 25 is lowered into the well casing 31 until the electrode tip 36 and ground tip 39 are at the bottom of the casing or in the cavity created by casing withdrawal.

The probe assembly 25 is fired to create the electro-plasma effects described above. The tar sand material is fused into a tar-rich layer. The tar rich fused layer can then be recovered as a liquid using conventional means. U.S. Pat. No. 4,067,390 to Camacho et al. discloses one way wherein a separate recovery bore is drilled to get the recovered hydrocarbonaceous material. Another technique is the “huff and puff” method wherein steam is injected into a deposit via one bore, and the hydrocarbonaceous material and water is recovered via another bore. Of course, other known techniques for recovering the fused hydrocarbonaceous tar sand layer can be employed as would be within the skill of the artisan.

It should be understood that the circuit diagram described above is equally applicable to the recovery of hydrocarbon-bearing materials in an in-situ application. That is, instead of using a reactor and a medium or media, the probe is inserted directly into the deposit of the material, and the electro-plasma effect is utilized in-situ rather than in the reactor. While the circuit diagram if effective for dissociating the hydrocarbons from the hydrocarbon-bearing material, it is believed that the probe and related components, i.e., the trigger, capacitor, etc., should be scaled up in size so that a larger volume of material can be treated per cycle. Treating a larger volume of deposit makes the recovery process more efficient in terms of the time it takes to dissociate the hydrocarbon-bearing material. For example, although up to 2 microfarads are contemplated for the FIG. 1 embodiment capacitors, it is believed that higher values would be needed. Likewise, while a 110 volt power supply may be suitable in applications using the FIG. 1, larger power supplies, e.g., 480 volts, are likely to be needed for recovery of tar sands and the like, particularly since the power must be supplied along the entire length of the probe to the bottom of the well casing.

As noted above, it should also be understood that once the tar rich deposit is formed, it can be removed using any of a number of conventional means, such as pumps, steam ejectors, forcemains, and the like. Once recovered, the tar rich deposit can then be further processed in a refinery to utilize the hydrocarbons for various applications. Since the refining processes for tar sands are well known, a further description thereof is not deemed necessary for understanding of the invention.

While a mobile unit is depicted, the probe assembly and recovery assembly could be mounted in a stationary manner on fixed supports. The fixed assemblies could then be dismounted and moved for drilling in another locale.

While the ground is depicted as a separate grounding rod extending along the insulator or into the ground, the well casing itself could be used as a ground connector, with a grounding tip attached thereto, or wherein the end of the casing itself could act as the grounding tip. In a further embodiment, the ground tip 39 can be supported by the insulator, and the ground tip is connected to the well casing via a leaf spring or other flexible and conductive member.

As such, an invention has been disclosed in terms of preferred embodiments thereof which fulfill each and every one of the objects of the present invention as set forth above and provides a new and improved method and apparatus for recovering hydrocarbons from hydrocarbon-bearing material, particularly tar sands.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. In a method of dissociating materials by first providing a material to be dissociated, subjecting said material to at least one cycle of a release of an electrical charge in a time span on an order of a nanosecond to impact a cycle shock front to the material for dissociation; and recovering at least one of said medium/media and at least one dissociated product from said subjecting step, the improvement comprising subjecting an in-situ deposit of hydrocarbon-bearing material to the at least one cycle and recovering a dissociated hydrocarbon-rich product from the subjecting step.

2. The method of claim 1, wherein the hydrocarbon-bearing material is a tar sand.

3. The method of claim 1, wherein a well casing is inserted into the hydrocarbon-bearing material and an end of a probe is inserted into the well casing until the probe end is in proximity to the deposit; and the electrical charge is released through the probe into the deposit to create a fusion layer of hydrocarbon-rich product for recovery.

4. The method of claim 3, wherein the subjecting step is repeated, the probe being lowered further into the deposit with each repetition.

3. The method of claim 3, wherein a grounding rod tip is disposed adjacent the probe end, the grounding rod tip connected to either a grounding rod extending back through the well casing and to ground or a ground rod extending into ground below the probe end.

4. The method of claim 4, wherein the grounding tip is adjustably spaced from the probe end.

5. In an apparatus for dissociating materials comprising a power supply; a capacitor for storing an electrical charge supplied by the power supply; a trigger switch for discharging the electrical charge stored in the capacitor in a time span on an order of a nanosecond; at least one probe, one end connected to the trigger switch for receiving the electrical charge discharged by the trigger switch, the other end of the probe immersed in the media; and a ground circuit including a ground tip disposed opposite an end of said probe, and a ground connector providing connection between ground and said ground tip, the improvement comprising a well casing extending into a deposit of hydrocarbon-bearing material, the probe positioned within the well casing, the probe end positioned adjacent a portion of the deposit for subjecting the deposit of hydrocarbon-bearing material to the electrical charge to form a dissociated hydrocarbon-rich product for subsequent recovery.

6. The apparatus of claim 5, wherein the apparatus is mounted on a mobile unit.

7. The apparatus of claim 5, wherein the ground tip is adjustable with respect to the end of the probe.

8. The apparatus of claim 5, wherein the ground connector connects to ground below the probe end.

9. The apparatus of claim 5, wherein the ground connector extends through the well casing from the ground tip and connects to ground outside of the casing.

10. The apparatus of claim 5, wherein the ground connector is the well casing.
